(19) United States
(12) Patent Application Publication
(10) Pub. No.: US 2024/0374017 A1
(43) Pub. Date: Nov. 14, 2024

(54) PANNIER BACKPACK

(71) Applicant: THULE SWEDEN AB, HILLERSTORP (SE)

(72) Inventors: Ryan MATHER, Boulder, CO (US); Eric HASSETT, Golden, CO (US); Lei SHAN, Denver, CO (US); Michael SCHMIDT, Lafayette, CO (US)

(21) Appl. No.: 18/650,461

(22) Filed: Apr. 30, 2024

Related U.S. Application Data
(60) Provisional application No. 63/501,524, filed on May 11, 2023.

(51) Int. Cl. A45F 4/02; B62J 9/24

(52) U.S. Cl. CPC A45F 4/02; B62J 9/24

(57) ABSTRACT

The present disclosure relates to a bag for transportation of personal items. The bag includes a main body and a panel. The bag is adjustable between a shoulder carrying configuration, in particular a backpack configuration, and a pannier configuration. The bag includes a panel attachment device that is configured to provide reversible mounting of the panel to an attachment side of the main body. The bag is adjusted into the shoulder carrying configuration when the panel is mounted to the attachment side of the main body with its first side facing away from the main body and is vice versa adjusted into the pannier configuration when the panel is mounted to the attachment side of the main body with its second side opposite the first side facing away from the main body.

### TECHNICAL FIELD

The present disclosure relates to a bag for transportation of personal items.

### BACKGROUND

Bags are commonly used to transport personal items, such as sports equipment, clothing or from grocery shopping. When walking, a backpack or messenger bag slung across the shoulder of the user might be one of the most comfortable ways of carrying a bag. However, this way of carrying a bag might be uncomfortable when not walking but instead using other means of transportation. In a city setting, bikes are a common means of transportation. A bag slung across the shoulder of the rider may cause discomfort and/or loss of balance while pedaling. Moreover, it might crumple and abrade the clothing worn by the user and negatively impair water-resistance. Hence, it is often preferable to have a bag attached to the bike instead of to the user when riding a bike. Just hanging the bag from the handlebars is a stopgap solution that will only be acceptable to most users for very short distances. Conventional shoulder bags are therefore uncomfortable to use with a bike. Hence, bags commonly used with bikes are panniers that may be attached to the side at a front and/or back of the bike.

When the user parks the bike, panniers are often removed to avoid theft and to temporarily act as a bag if the user did not bring a different type of bag for use when not riding the bike as well, such as a shoulder bag. However, panniers are usually uncomfortable to carry around while on foot, for example due to rigid elements for attaching the pannier to the bike and handles and straps being placed in uncomfortable positions to avoid interference with the bike. Hence, panniers may be uncomfortable to use in any setting except when riding a bike. Carrying both a shoulder bag and a pannier is also undesirable due to the weight penalty, the need to store the bag currently not in use and potentially being required to relocate the personal items from one bag to the other when switching the mode of transportation.

DE 20 2021 002 582 U1 describes a bag that can be adjusted between a backpack configuration and a pannier configuration. For that purpose, the bag comprises a flap hingedly fixed to the side of a main body. The flap has shoulder straps attached to one side and bike fixation elements to another side opposite that side. The flap wraps around a first side of a main body in one position, thus providing backpack shoulder straps on the outside. In another position, the flap wraps around a second side of the main body opposite the first side, thus providing bike mounting elements on the outside for attaching the bag to a bike. The bag may thus be used as backpack and as a pannier. However, depending on flap position, an access to an interior of the bag may be limited or at least different, rendering retrieval and storage of personal items cumbersome and unintuitive. Furthermore, the hinged fixation of the flap renders the bag susceptible to high loads. For example, the flap may unwantedly detach from the main body at its side opposite the hinged fixation when the items in the bag are too heavy. Moreover, high loads, for example due to heavy personal items stored in the bag, may cause the flap and/or main body to deform a lot at the attachment points, resulting in a shape uncomfortable to use. In addition, wrapping the flap around the bag from one side to the other to change between pannier mode and backpack mode might be difficult depending on how full the bag has been packed. With a full bag, it may be difficult to still wrap the flap so far around that the free end can be reattached.

Other bags that can be adjusted between backpack use and pannier use usually require the removal or mounting of an element, such as a cover plate having the shoulder straps. In such a case, such a part of the bag currently not in use can be lost easily. Moreover, when not in use, such an element needs to be stored, potentially limiting interior space in the bag or not being available when the user wants to change the mode of usage. Overall reconfiguring the bag may be difficult with such a design.

### SUMMARY

A first aspect relates to a bag for transportation of personal items. For example, personal items may comprise clothing, sport equipment, a laptop and/or groceries. Usually, the personal items may be transported in an interior of the bag, although in addition external attachment may also be possible.

The bag comprises a main body. A main body may, for example, be formed from a textile and/or rigid elements. The main body may have a hard shell or soft shell. The main body may provide an interior in which the personal items may be stored for transportation. Access to the interior may be provided through one or several openings in the main body. The main body may comprise means to close each opening, such as a flap, zippers, hooks and/or buttons. The main body may also provide external attachment for personal items, for example with loops and/or straps. The main body has an attachment side. The attachment side may be one side of the body, in particular a side upright during common use of the bag. For example, the attachment side may be a back side of the bag. The main body may essentially have a cube shape, in which the attachment side forms one side. The main body may also have a more rounded shape. The attachment side may be essentially planar or may have some other shape, such as a concave shape. The attachment side may be a side or section of the main body usually facing the user when the bag is carried and/or facing the bike when the bag is attached to a bike. The main body may, for example, form a suitcase, briefcase or pouch-like bag. The main body may be formed from several elements sewn together. One or several such elements may form the attachment side. The main body may comprise additional interior and/or exterior pockets.

The bag further comprises a panel with a first side and a second side opposite to the first side. The first side may be largest side of the panel with the exception of the second side. The second side may have a shape and/or size identical to the first side. The panel may be a rigid or somewhat flexible plate. The panel may be formed from a sheet of foam or rigid plastic covered with a textile covering. The panel may comprise a frame. For example, the panel may be formed from a frame with a central net tensed in between. Such a configuration may improve air circulation at the back of the user when carrying the bag. The panel may be a part of the bag that is separate from the main body. The panel may be free of an interior. Alternatively, the panel may have a small pocket, for example in the fabric covering a rigid plastic or foam plate. The panel may be configured as a back panel. The bag may comprise compression straps and/or zippers for size adjustment, in particular for compressing an interior space. The compression straps and/or zippers for size adjustment may be attached to the main body and/or the panel.

The bag is adjustable between a shoulder carrying configuration, in particular a backpack configuration, and a pannier configuration. A shoulder carrying configuration may make a strap available for slinging the bag around the shoulder. For example, the bag may be carried with a single shoulder strap across one shoulder and the chest of the user. A backpack configuration may make two shoulder straps available for easy carrying of the bag on the back of the user. Each shoulder strap may be slung around one corresponding shoulder. The bag may additionally comprise a chest strap to attach the two shoulder straps to each other to prevent the shoulder straps from slipping of the shoulders of the user. Optionally, the bag may also make a hip strap available in the backpack configuration. The pannier configuration allows the bag to be attached to the side of a bike or motorcycle, in particular without interfering with the usage of the bike. A bike may, for example, be configured as a touring bike, as a mountain bike or a racing bike. The adjustability allows a user to comfortably use the bag both when walking and when riding a bike.

The bag comprises a panel attachment device that is configured for reversible mounting of the panel to the attachment side of the main body. The panel attachment device may be configured to attach the panel to the main body so that a maximum rated carrying load can be transmitted from the panel to the main body and vice-versa. The panel attachment device may be configured for quick attachment of the panel to the main body and/or quick release of the panel from the main body, for example with one or several snap-connectors and/or hook-and-loop fasteners, such as corresponding Velcro straps on the panel and the attachment side of the main body. The panel attachment device may provide a detachable fixation of the panel to the main body. The panel attachment device may comprise corresponding attachment elements on the main body and the panel, for example on the attachment side of the main body and on edges of the panel. An edge of the panel may extend around both sides and connect the first and second side of the panel. For example, the edge of the panel may be formed by thin ends extending between the two sides. The attachment device may, for example, comprise a zipper, hook-and-loop fasteners, straps, buttons, hooks, snap attachments, magnets or any combination thereof as attachment elements for mounting the panel. The same or different attachment elements may be used to mount the panel in the pannier configuration and the shoulder carrying configuration. The main body and the panel may comprise corresponding attachment elements at corresponding positions.

The bag is adjusted into the shoulder carrying configuration when the panel is mounted to the attachment side of the main body with its first side facing away from the main body, in particular its attachment side. The bag is adjusted into the pannier configuration when the panel is mounted to the attachment side of the main body with its second side facing away from the main body, in particular its attachment side. In the shoulder carrying configuration, the second side of the panel may face towards the main body. In the pannier configuration, the first side may face towards the main body, in particular its attachment side. The first side of the panel may form a shoulder carrying or backpack side of the panel. The second side may form a pannier side of the panel.

In each configuration of the bag the panel may thus be attached on the same side of the main body. For changing configuration, the panel may simply be detached from the main body, be flipped around, and be reattached. Configuration adjustment is thus quick and easy. Flipping around the panel may make different elements for carrying on the shoulder or attaching the bag to a bike available due to a different side facing away from the main body and forming an exterior of the bag, respectively. Depending on an arrangement of the elements for using the bag as a shoulder carrying bag or pannier, the panel may be flipped around a vertical or horizontal axis of the panel. The vertical and horizontal axis, as well as up and down, may relate to the bag standing upright with the panel attached. For example, in the backpack configuration, the orientation of the bag and thus mounted panel may be defined by the user carrying the bag on his back with straps resting on his shoulders while standing upright.

The side and thus elements for carrying or attaching the bike facing the main body may be covered by the main bag. This may also keep those elements not used in a certain configuration, such as shoulder straps in the pannier configuration, in place. For example, the shoulder straps may be wedged between the main body and the panel in the pannier configuration, preventing such straps from potential entangling with a bike wheel or pedal. For example, the panel may be mounted in the same position on the main body in each configuration. The panel is thus intuitive to position and mount. Further, the panel does not cover or otherwise obstruct pockets, openings and/or exterior attachment elements of the main body in one configuration but not the other, unlike other bags that may be adjusted between a pannier and backpack configuration. Access to the interior and/or pockets of the main body or even the whole bag may remain the same in each configuration. The bag is thus intuitive to use in each configuration. Moreover, the panel may be attached to the main body in each configuration in the same or a similar manner. Hence, loading the bag with personal items in one of the configurations will not interfere with mounting of the panel in another of the configurations so that configuration adjustment may remain simple regardless of bag loading.

According to an embodiment of the bag, the panel comprises a shoulder carrying device arranged on the first side. The shoulder carrying device may comprise at least once shoulder strap. The shoulder carrying device is configured to provide means to the user for carrying the bag with their shoulder when the bag is in the shoulder carrying configuration. The at least one shoulder strap may be attached with both ends to the first side of the panel. In this case, the shoulder strap may be available for use immediately after mounting the panel in the orientation required for the shoulder carrying configuration. One end of the shoulder strap may also be attached to the main body. In this case, the shoulder strap may be required to be detached from and reattached to the main body when adjusting between the two bag configurations. The shoulder strap may have a particular comfortable position for wearing the bag in this case. The shoulder carrying device may comprise two or more shoulder straps. Each strap may be attached with its one end to one end of the panel, such as an upper end section and/or first end of the panel, and with its other end to another end of the panel, such as an opposite, second and/or lower end of the panel. Each shoulder strap may be configured for carrying the bag in the shoulder carrying configuration, for example by resting on the shoulder of the user. A shoulder strap may be formed from a webbing. A shoulder strap may optionally comprise a cushion, in particular a fixed cushion or a cushion moveably attached along the webbing. A shoulder strap may be configured as length-adjustable. The shoulder straps may be permanently or removably attached to the panel.

According to an embodiment of the bag, the shoulder carrying device comprises a hip belt arranged on the first side of the panel. The hip belt may be arranged on the first side of the panel in both the shoulder carrying configuration and the pannier configuration. The hip belt may also only be arranged on the first side of the panel in the shoulder carrying configuration. For example, the hip belt may be arranged at a lower section of the first side of the panel when the panel is mounted to the main body. A hip belt may be formed by a webbing, optionally with cushions. A hip belt may comprise a quick connector for opening and closing the hip belt. A hip belt may be configured for length adjustment. A hip belt may be configured as a strap. The hip belt may be slung around the hip of the user when carrying the bag in the shoulder carrying configuration, stabilizing the bag and distributing load to the hip of the user for a comfortable carrying of the bag. The hip belt may be attached with both ends to the first side of the panel. In this case, the panel may provide a carrying frame for using the bag as backpack, which may be particularly comfortable. The hip belt may also be attached with one or both ends to the main body. In this case, the hip belt may also stabilize the panel during mounting when not yet fully attached. Moreover, in this case the hip belt may also easily be used to support attaching the bag to the bike in the pannier configuration, for example reducing one degree of freedom of motion relative to the bike. In the pannier configuration, the hip belt attached to the main body may, for example, be stored in a compartment on the main body or adjusted to be flatly tightened around the main body. The hip belt may also act as a compression strap in this case. The hip belt may be permanently or removably attached.

According to an embodiment of the bag, the bag is configured to form a first compartment between the panel and the main body in the pannier configuration for receiving the at least one shoulder strap. For example, the attachment side of the main body and the first side of the panel may form walls of the first compartment. The first compartment may not be present in the shoulder carrying configuration. The first compartment may receive all shoulder straps in the pannier configuration and optionally the hip belt. The first compartment may be configured for receiving the whole shoulder carrying device in the pannier configuration. The first compartment may thus safely store the shoulder carrying elements when the bag is used as a pannier. This may prevent any shoulder carrying elements getting dirty while riding the bike or entangling with wheels. The attachment side of the main body may be concave, thus providing a larger space in the first compartment. Further, this may allow the panel to be flat without any shoulder carrying elements pressing against the main bag and especially the interior or being pressed outward against the panel when the bag is full. The panel may be configured as a flat sheet.

According to an embodiment of the bag, the bag comprises a bike attachment device. The bike attachment device may comprise bike attachment elements for attaching the bag in the pannier configuration to the side of the bike. The bike attachment device may be configured for attachment of the bag to a luggage rack of the bike, such as a rear and/or front luggage rack. Alternatively or additionally, the bike fixation device may be configured for attachment of the bag to parts of a frame of the bike, such as a seat post and/or rear chain stay.

According to an embodiment of the bag, the bike attachment device comprises a first bike attachment element arranged on the second side of the panel. The first bike attachment clement may, for example, comprise a clasp, hook, rail and/or strap. The first bike attachment clement may be attached to the second side of the panel. For example, a bike attachment rail may be screwed to the second side of the panel, in particular opposite a shoulder carrying strap. Alternatively or additionally, the first bike attachment element is arranged at a first end of the second side of the panel. The first end of the second side of the panel may be an upper end. The first bike attachment element may be configured for hanging the bag in the pannier mode at an upper end on the side of the bike. This allows the first bike attachment element to withstand high loads and movement of the bag relative to the bike is already very limited without any further attachment points. If an upper end of the two shoulder straps and the first bike attachment element are arranged at the same end of the panel on opposite sides, the panel is usually turned around its vertical axis for adjusting the bag configuration. This may keep dirt collected on the bag, in particular the panel and/or during use as a pannier, at the bottom in each configuration, which is usually less bothersome for the user, in particular when subsequently using the bag with collected dirt as a backpack or messenger bag.

According to an embodiment of the bag, the bike attachment device comprises a second bike attachment element. Such a second bike attachment element may further restrict movement of the bag relative to the bike when attached thereto, for example preventing the bag from tilting away from the bike around the first bike attachment element when riding through a curve. For example, the second bike attachment element may be attached to the attachment side of the main body or attached to the second side of the panel. For example, the second bike attachment clement may be formed by a Velcro strap, a hook, loop, or clip. The second bike attachment element may be formed by the optionally provided hip belt or may be a part separate thereto. The bike attachment device may only use elements not being part of the shoulder carrying device and vice-versa. The second bike attachment element may be arranged at a second end of the second side of the panel. Alternatively, the second bike attachment clement is arranged at middle section of the second side of the panel. The middle section may be situated between the first end and the second end. The middle section might be about halfway between an upper end and a lower end. Such a position of the second bike attachment element may allow to use the second bike attachment element to hold the panel upright during mounting to the main body. The second end of the panel may be arranged opposite to its first end.

According to an embodiment of the bag, the bike attachment device comprises a bumper arranged at a second end of the second side of the panel. The bumper may be combined with any of the above-mentioned bike fixation elements. For example, if the second bike fixation element is arranged at the second end, it may be arranged on top of the bumper or the bumper may comprise a recess for that second bike fixation element, thus surrounding it. The bumper may be attached to the panel or may form an integral part of the panel and in particular its second side. The bumper may be made from a soft and/or compliant material. For example, the bumper may protrude from an otherwise flat second side of the panel. The bumper may be formed by a softer material than the rest of the panel. The bumper may rest against the frame of the bike when the bag is attached to the bike in the pannier configuration. The bumper may prevent abrasion of paint from the frame of the bike. Further, the bumper may dampen a hit of the pannier on the bike when the bag is moving relatively to the bike. The bumper may thus render lower attachment for swing prevention of the pannier unnecessary, in particular if the bag is primarily used in a tar road and/or city setting.

According to an embodiment of the bag, the bag is configured to form a second compartment between the panel and the main body in the shoulder carrying configuration for receiving the bike attachment device. The second compartment may be provided in addition to the first compartment. The bag may also be free of the previously described first compartment. For example, the attachment side of the main body and the second side of the panel may form walls of the second compartment. The second compartment may not be present in the pannier configuration. The second compartment may receive all bike fixation elements and/or the bumper in the shoulder carrying configuration. The second compartment may thus safely store the bike fixation elements when the bag is used as a bag carried on the shoulders. This may prevent any bike attachment elements from catching on the environment. The attachment side of the main body may be concave, thus providing a larger space in the second compartment. Further, this may allow the panel to be flat and/or the bike attachment elements to be rigid and hard parts without pressing uncomfortably against the user, in particular against a back of the user, when the bag is in the shoulder carrying configuration.

According to an embodiment of the bag, the panel is configured as a rigid element. The panel may thus provide enough structural integrity to the bag, in particular to a bag with a soft main body, to allow transport of heavy loads and/or safe attachment to the bike. For example, the panel may be formed from a flat plastic or foam sheet with an optional textile cover. The panel may comprise padding, in particular on the first side for a more comfortable use as backpack and/or if the panel is rigid. Alternatively, the panel may be configured as a limp clement, for example formed from a sheet of textile. The bag may be particularly small to pack in this case.

According to an embodiment of the bag, the panel attachment device comprises a first panel attachment element fixed to the main body and a corresponding second panel attachment element fixed to the panel. The first and second attachment element are configured for fixation to each other to fix the mounted panel in place at the attachment side of the main body. The same or different pairs of first and second attachment elements may be used for fixing the panel to the main body in the pannier configuration and the attachment configuration. The first panel attachment element may, for example, be fixed to the attachment side of the main body. The second panel attachment element may be fixed to the first side, second side or edge of the panel. If the second attachment element is fixed to the edge of the panel, it can easily be used for the attachment of the panel to the main body in both configurations of the bag. The first panel attachment element and the second panel attachment element may be configured to provide a continuous attachment along a section of an edge of the panel, in particular an upper section or around the whole edge of the panel. For example, the two panel attachment elements may be formed as sides of a zipper or a loop strap and hook strap of a hook-and-loop fastener that are attached to each other. A continuous attachment may potentially casily support high loads.

The panel attachment device may comprise a plurality of first panel attachment elements and a plurality of second panel attachment elements. Each of these pairs of attachment elements may be different or identical. The first panel attachment elements may be fixed to the main body and the second panel attachment elements may be fixed to the panel. Each first and second panel attachment element may be configured as detailed above for just one pair of such elements. The second panel attachment elements may be arranged along an edge of the panel. At least a pair of second panel attachment elements are arranged on opposite edge sections of the panel, for example an upper edge and a lower edge of the panel. The first and/or second panel attachment elements may be arranged spaced apart on the main body and/or the panel, respectively. All first panel attachment elements may be fixed to the attachment side of the main body and not to other sides of the main body. The panel attachment device may thus provide a secure and intuitive mounting for the panel.

According to an embodiment of the bag, the panel attachment device comprises a pocket formed by the main body at the attachment side. The pocket may be configured for receiving an end section of the panel, in particular a corner section. The pocket may form a first panel attachment element of the panel attachment device. The corner or side of the panel inserted into the pocket may form a second panel attachment element. Such an attachment may allow very easy and quick mounting of the panel to the main body in each configuration. For example, it may be required to slightly bend or otherwise deform the panel to insert all appropriate sections or corners into corresponding pockets. The panel may be tensioned when mounted to the main body. The panel may thus be held very securely in the pocket.

The pocket may be configured for receiving an end section, in particular the same end section, of the panel in both the pannier and the shoulder carrying configuration. For example, a first pocket may be provided for a lower left corner and a second pocket for a lower right corner of the panel. The panel may comprise a central bottom recess in this case to form insertable corners. Alternatively, there may be just one central lower pocket. The panel may comprise a central bottom protrusion forming an insertable corner in this case. For example, there may be provided a third pocket for an upper left corner and a fourth pocket for an upper right corner of the panel. The panel may comprise a central top recess in this case to form insertable corners. Alternatively, there may be just one central upper pocket. The panel may comprise a central top protrusion forming an insertable corner in this case. The panel attachment device may just comprise lower or upper pockets. Lower pockets facilitate mounting of the panel since the panel can already be held before full attachment to the main body. Upper pockets allow high load transmission since a heavy bag may just hang from the panel with its pockets when carried. If pockets are only arranged at the top or the bottom, they may also be combined with other attachment means, such as a hook-and-loop fastener or a zipper. The panel may be configured for elastic deformation when inserted into the pocket. Nevertheless, the panel may still be considered rigid as opposed to limp when being configured for such a deformation. The main body may also have a circumferential gap or slit as a pocket, for example configured for receiving the whole circumferential edge of the panel.

According to an embodiment of the bag, the attachment device comprises a zipper. For example, the panel attachment device may comprise only a single zipper. Other zippers, such as for obstructing openings in the main bag, may not form part of the panel attachment device. A zipper is a simple to use and sturdy means for attaching the panel to the main body. The zipper may withstand high loads and provide a very secure attachment of the panel to the main body. The zipper may be arranged at a top section of the bag. The same zipper may be used for attachment in the two configurations. Only parts of the zipper, such as a zipper side piece on the main body, may be used for attachment in the two configurations. The bag may also comprise zippers or zipper parts only used for panel attachment in one of the two bag configurations. For example, the attachment device may comprise two zippers. A zipper may comprise a slider mounted on two rows of metal or plastic teeth that are designed to interlock and thereby join the material to which the rows are attached. The rows of teeth with attached other parts, such as a tape to which the teeth are attached, may form a side piece of the zipper. A slider of the zipper, usually operated by hand, may contain a Y-shaped channel that, by moving along the rows of teeth, meshes or separates the teeth and thus the side pieces of the zipper. The slider may be permanently attached to one side piece of the zipper.

According to an embodiment of the bag, the zipper comprises a single zipper side piece attached to the attachment side of the main body, a first zipper side piece attached to the panel, in particular to the second side of the panel, and a second zipper side piece attached to the panel, in particular to the first side of the panel. The zipper is configured for the first zipper side piece to be zipped together with the single zipper side piece of the main body when the panel is mounted to the main body in the shoulder carrying configuration. The second zipper side piece may not be zipped together with anything in the shoulder carrying configuration. The zipper is configured for the second zipper side piece to be zipped together with the single zipper side piece of the main body when the panel is mounted to the main body in the pannier configuration. The first zipper side piece may not be zipped together with anything in the pannier configuration. As a result, a number of parts can be low while panel attachment in both configuration is easy and intuitive. For example, with such a design, the zipper can always be moved in the same direction for closing and opening of the zipper, regardless of whether the panel is mounted with its first side or its second side facing towards the attachment side of the main body.

The slider of the zipper may be attached to the main bag, in particular the single zipper side piece of the main body. The zipper thus only needs one slider, resulting in low weight and costs. Zipper side pieces of the panel may be arranged at the first end, such as the top end, of the panel. The zipper side pieces of the panel may extend partially along an edge of the panel, for example along a top half or third of the edge of the panel. The bottom end of the panel may be mounted into one or more pockets or attached by hook and loop fasteners. The zipper side pieces may be permanently attached to the main body or panel, respectively, for example with sutures or glue. Alternatively, the panel may also only comprise a single zipper side piece for attachment to the single zipper side piece of the main body to mount the panel to the main body in both the shoulder carrying configuration and the pannier configuration.

According to an embodiment of the bag, the panel attachment device comprises a grasping element, in particular formed as a webbing loop, fixed to a zipper alignment end of the panel. The grasping element may be configured for guiding a zipper alignment end of the panel into a corresponding zipper alignment end of the main body. The grasping element may thus help the user to attach the free ends of two corresponding zipper side pieces to each other to close the zipper, thus mounting the panel to the main body and adjusting the bag into a certain configuration. A zipper alignment end may be formed by zipper side piece fixed to the panel. A zipper alignment end may be configured for attaching two side pieces of a zipper. For example, the zipper alignment end may be formed by an insertion pin or pin box. The grasping element may be configured as a pull tab.

According to an embodiment of the bag, the panel comprises a first carrying handle on the first side of the panel, in particular with the first carrying handle fixed to the first side of the panel. The panel may alternatively or additionally comprise a second carrying handle on the second side of the panel, in particular with the second carrying handle fixed to the second side of the panel. This may allow to easily carry the bag in each configuration and/or just the panel. The first and/or second carrying handle may be arranged at a first end of the panel and or at the end of the side of the panel with the respective carrying handle attached thereto facing away from the main body and/or being arranged at the top in the respective configuration. For example, the carrying handle may be formed by a bar or webbing. A middle section of a carrying handle may have a round cross section for comfortably holding the carrying handle by hand. Alternatively, there may only be a single carrying handle, for example attached to a top edge of the panel. A carrying handle may extend vertically or horizontally with the bag arranged upright.

Other features of the bag of the present disclosure will be apparent from consideration of the information contained above as well as in combination with the following detailed description, drawings and claims. The bag of the present disclosure is illustrated by way of example, and not by way of limitation, in the figures of the accompanying drawings.

### BRIEF DESCRIPTION OF FIGURES

FIG. 1 shows, in a schematic perspective view, a first embodiment of a bag for transportation of personal items with a main body and a panel attached thereto.

FIG. 2 illustrates, in a schematic perspective view, the bag according to FIG. 1 in a pannier configuration and attached to a bike.

FIG. 3 illustrates, in a schematic perspective view, the bag according to FIG. 1 in a backpack configuration.

FIG. 4 shows, in a schematic perspective view, the bag according to FIG. 1 in a backpack configuration worn by a person.

FIG. 5 shows, in schematic perspective view from an attachment side, the main body of the bag according to FIG. 1 without the attached panel.

FIG. 6 shows, in schematic perspective view from an attachment side, the main body and the panel of the bag according to FIG. 1 separate from each other.

FIG. 7 shows, in a front view, the panel of the bag according to FIG. 1 with a second side of the panel facing towards the viewer, the panel having a first bike attachment element at an upper first end and a bumper at a lower second end.

FIG. 8 shows, in a perspective view, the panel of the bag according to FIG. 7 turned slightly to the side to illustrate movement of the panel for configuration change of the bag according to FIG. 1.

FIG. 9 shows, in a perspective view, the panel of the bag according to FIG. 7 turned further so that a first side of the panel is facing the viewer to also illustrate movement of the panel for configuration change of the bag according to FIG. 1.

FIG. 10 shows, in a front view, the panel of the bag according to FIG. 1 with the first side of the panel facing towards the viewer, the panel having a shoulder carrying device comprising two shoulder straps.

FIG. 11 illustrates a second embodiment of the bag with the main body in a frontal view from the attachment side and the panel in a frontal view from both sides.

FIG. 12 shows, in a frontal view, the bag according to FIG. 11 in the pannier configuration.

FIG. 13 shows, in a frontal view, the bag according to FIG. 11 in the backpack configuration.

FIG. 14 illustrates, in a frontal view from the attachment side, the panel of a third embodiment of the bag, the third embodiment having a panel attachment device with a zipper.

FIG. 15 illustrates, in a frontal view from the second side, the panel of the third embodiment of the bag.

FIG. 16 illustrates, in a frontal view from the first side, the panel of the third embodiment of the bag.

FIG. 17 illustrates, in an exploded perspective view, parts of the panel of the third embodiment of the bag.

### DETAILED DESCRIPTION

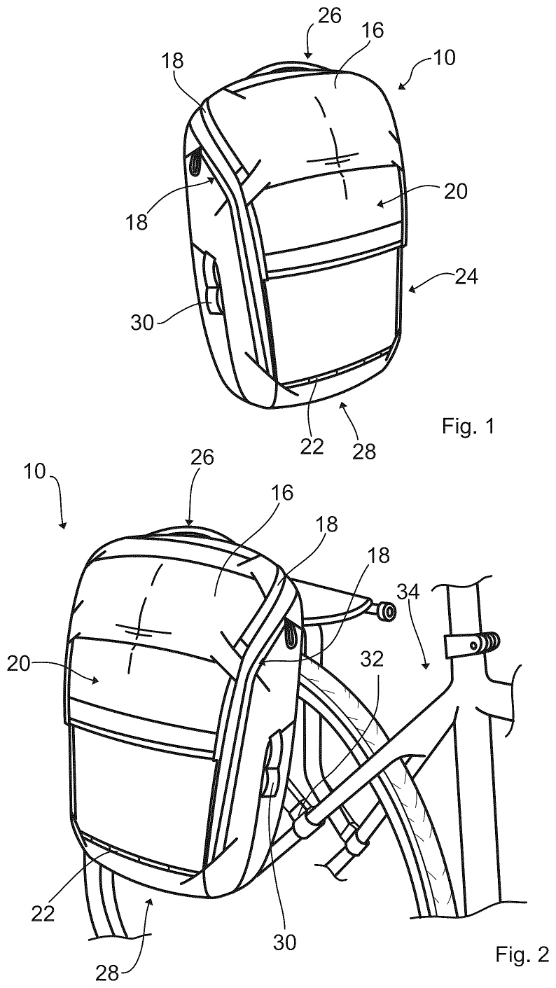

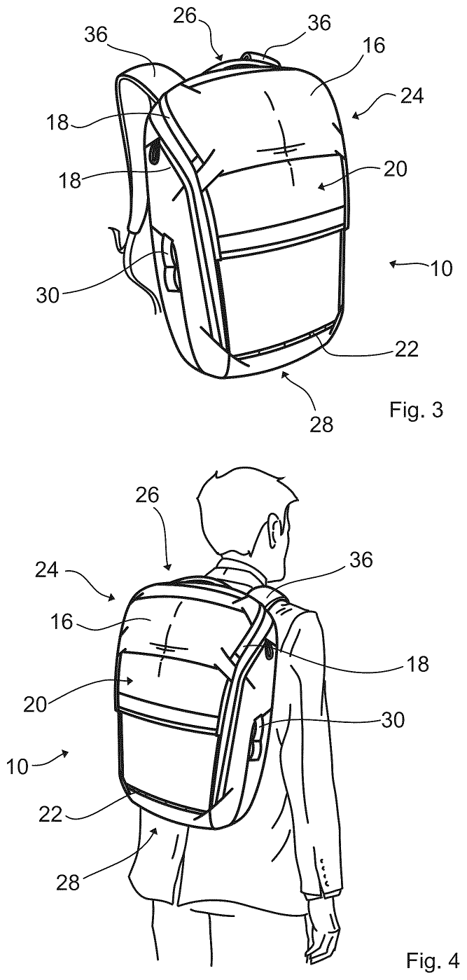

FIG. 1 shows a bag for transportation of personal items according to a first embodiment. The bag can be adjusted between a shoulder carrying configuration, in particular a backpack configuration as shown in FIGS. 3 and 4, and a pannier configuration as shown in FIG. 2. The bag comprises a main body 10 and a panel 12 attachable thereto. The panel 12 is, for example, shown in FIG. 6. The bag comprises an attachment device that is configured for reversible mounting of the panel 12 to an attachment side 14 of the main body 10. The attachment side 14 is facing towards a bike when the bag is attached to the bike in the pannier mode and towards the user when worn as a backpack. A side opposite the attachment side 14 forms the front side 24 of the bag and the main body 10. The bag is shown in FIGS. 1 to 4 from the front side 24.

The main body 10 forms the compartment for transportation of personal items. The panel 12 provides the means to carry the bag as a backpack and to attach the bag to a bicycle for use as a pannier. The main body 10 has a zippered pocket in a top flap 16. Accordingly, such a first end 26 of the bag forms an upper or top end of the bag. The main compartment for transporting personal items is arranged underneath the top flap 16 and is accessible by a zipper 18. Further, the main body 10 has further zippered pockets and webbing loops 30 for light attachment at each side. The main body 10 also forms a front pocket 20. At a second end 28 of the bag, which is a lower or bottom end of the bag, a daisy chain 22 is arranged on an outer side of the front side 24 of the main body 10. The front side 24 and the first end 26 of the bag and the main body 10 remain equally accessible regardless of whether the bag is in its pannier configuration or backpack configuration.

FIG. 2 shows the bag in the pannier configuration attached to a rear luggage rack 32 of a bike 34. FIG. 4 shows the bag worn by a user as a backpack. As can be seen, orientation for main compartment and pocket access remains the same and each exterior compartment access and attachment point can be accessed in the same manner regardless of whether the bag has been adjusted into the pannier or backpack configuration. FIG. 3 shows that the panel 12 has been turned around so that length adjustable shoulder straps 36 of a shoulder carrying device are protruding from the bag. FIG. 1 shows the bag in the pannier configuration so that the shoulder straps 36 are stored away.

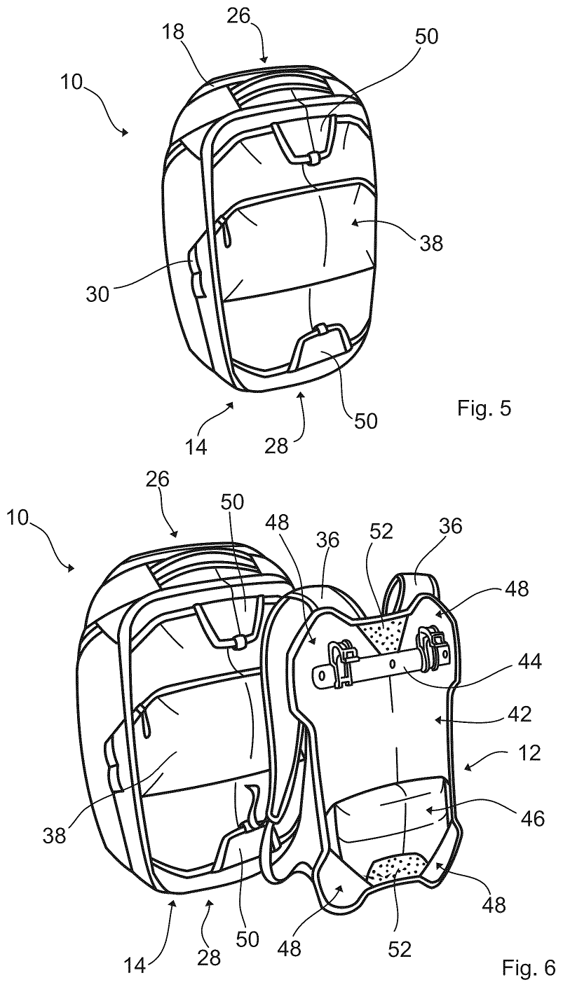

FIG. 5 illustrates the main body 10 in a perspective back view and thus from the attachment side 14 without the panel 12 attached. As can be seen, the main body 10 is slightly concave at the attachment side 14 to accommodate any elements protruding from the panel 12 towards the main body 10. The bag is thus configured to form a first compartment between the panel 12 and the main body 10 in the pannier configuration for receiving the shoulder carrying device, which is formed in the first embodiment by the shoulder straps 36. The bag is configured to form a second compartment between the panel 12 and the main body 10 in the shoulder carrying configuration for receiving a bike attachment device, which will be detailed further below. Both compartments may be of equal size but are limited by opposite sides of the panel 12. The main body 10 is gusseted around an edge of the attachment side 14 to allow easy mounting of the panel 12 and to facilitate using the full interior size of the bag despite the panel 12 and the before-mentioned compartments.

The bag comprises an optional hidden zippered pocket 38 formed on the attachment side 14 of the main body 10. The hidden pocket 38 is only accessible when the panel 12 is removed. The hidden pocket 38 is covered by the panel 12 mounted to the main body 10. The hidden pocket 38 therefore allows for very secure storage of valuables.

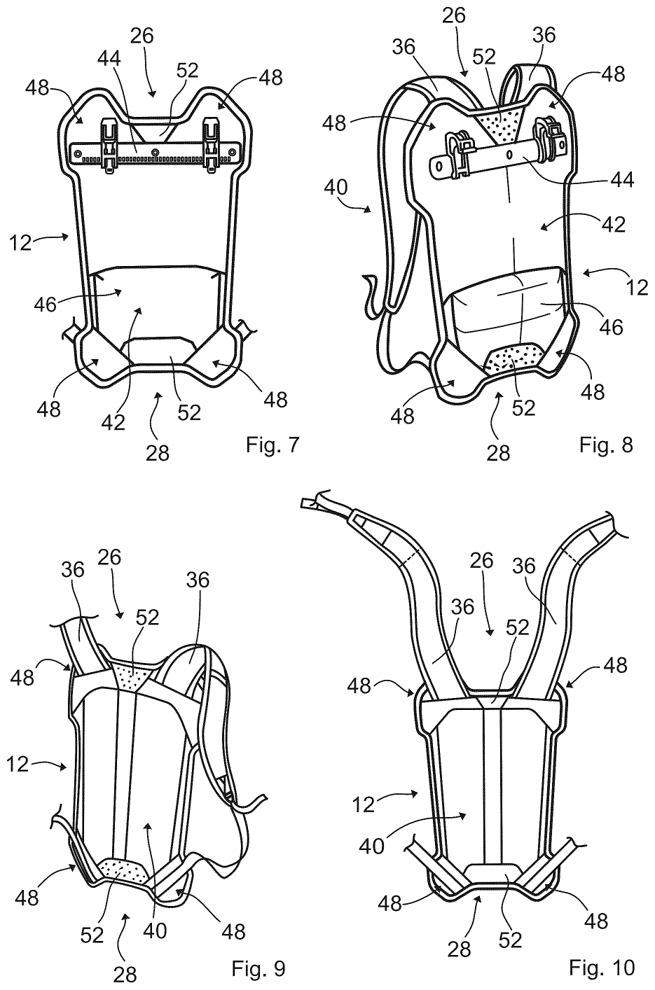

FIGS. 7 to 9 illustrate how the panel 12 can be turned around an upright central axis so that either a second side 42, shown in FIGS. 7 and 8, or a first side 40, shown in FIGS. 9 and 10, is facing towards a user. If the panel 12 is mounted to the main body 10 with its first side 40 facing towards the user and away from the main body 10 and the second side 42 thus facing towards the attachment side 14 of the main body 10, the bag is adjusted into the shoulder carrying configuration. As can be seen, in such a configuration the shoulder carrying device and thus the shoulder straps 36 are arranged on the outside of the bag and the bike attachment device is stored in the compartment between the main body 10 and the panel 12. If the panel 12 is mounted to the main body 10 with its second side 42 facing towards the user and away from the main body 10 and the first side 40 thus facing towards the attachment side 14 of the main body 10, the bag is adjusted into the pannier configuration. As can be seen, in such a configuration the bike attachment device is arranged on the outside of the bag and the shoulder carrying device is stored in the compartment between the main body 10 and the panel 12.

For this purpose, the bag comprises a panel attachment device that is configured for reversible mounting of the panel 12 to the attachment side 14 of the main body 10. In the first embodiment, the panel attachment device is formed by pockets of the attachment side 14 of the main body 10 and corresponding protruding corners 48 of the panel 12. The corners 48 are inserted into a pocket each to mount the panel 12 to the main body 10. The pockets are thus configured for receiving one or more end sections of the panel 12. The pockets may be formed in each corner of the attachment side 14 of the main body or there may be pockets configured to receive multiple corners. There may be a lower or larger number of corners, which may be formed by additional recess in an otherwise rectangular basic shape of the panel 12. For the purpose of inserting the corners 48 into the pockets, the panel 12 may be reversibly bendable. For example, the panel 12 is formed from a rigid but flexibly deformable flat foam with a textile covering. The panel 12 is thus held in the pockets by tension.

Additionally or alternatively, the panel attachment device comprises a Velcro fixation. One side of the Velcro fixation is formed by a flap 50 at each of the first end 26 and the second end 28 of the main body 10 that attaches to a corresponding section 52 at each of the first end 26 and the second end 28 of the panel 12. The sections 52 forming part of the Velcro fixation are arranged at both the first side 40 and second side 42 of the panel 12 to allow fixation in both the pannier configuration and backpack configuration. Preferably, a hook side of the Velcro fixation is arranged on the flaps 50 of the main body 10 and a loop side of the Velcro fixation is arranged on the panel 12. In this way, even in non-perfect alignment, no hooks should be exposed which could otherwise damage clothing worn by the user.

The corners 48 and pockets as well as the flaps 50 and sections 52 each form a pair of a first panel attachment element fixed to the main body 10 and a corresponding second panel attachment element fixed to the panel 12. Other configurations of pairs of first and second panel attachment elements are feasible, which will exemplary be described for other embodiments. Generally, in the shown embodiments, the second panel attachment elements are arranged along an edge of the panel 12 and/or at least a pair of second panel attachment elements are arranged on opposite edge sections of the panel 12. Also generally, in the shown embodiments, the first panel attachment element is fixed to the attachment side 14 of the main body 10. However, other arrangements are also possible. As can be taken from the figures, regardless of the embodiment, mounting the panel 12 is essentially identical whether the panel 12 is attached to the main body 10 for adjusting the bag into the pannier configuration or the backpack configuration.

The shoulder carrying device is arranged on the first side 40 of the panel 12. As can be seen, the shoulder straps 36 are attached with one end to a section at the first end 26 of the panel 12 and with an opposite end to an opposite section at the second end 28 of the panel 12. In the first embodiment, the shoulder carrying device also comprises cushions arranged at the first side 40 of the panel 12. The cushion has a vertical recess in a spinal area to improve air circulation and thus comfort when wearing the bag as a backpack.

In the first embodiment, the bike attachment device configured for attachment of the bag to the luggage rack 32 of the bike 34 comprises a first bike attachment element 44 arranged at the first end 26 on the second side 42 of the panel 12. The first bike attachment clement 44 is configured to let the bag hang from a bar of the luggage rack 32 of the bike 34. For this purpose, the first bike attachment element 44 comprises a bar with two clamps whose distance towards each other and position along the bar can be adjusted to different luggage racks. The first bike attachment element 44 may be configured for a snapping attachment with a quick release. The bike attachment device also comprises a bumper 46 arranged at the second end 28 of the second side 42 of the panel. The bumper 46 supports the bag in an upright manner against the luggage rack 32 and dampens any swinging movement against the luggage rack 32. The first embodiment omits a bottom bike attachment element for weight saving purposes, case of attachment and to increase comfort when wearing the bag as a backpack.

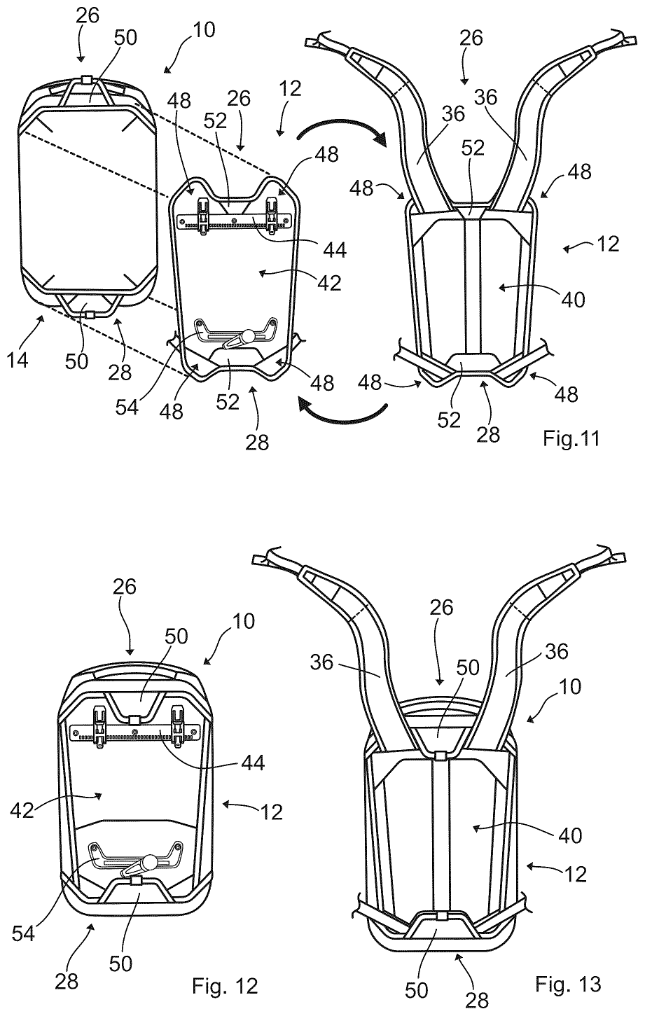

FIGS. 11 to 13 illustrate a second embodiment of the bag. In FIGS. 11 and 13, the shoulder straps 36 are illustrated as not being attached to the second end 28 of the panel 12. However, the shoulder straps 36 may be permanently closed. In some embodiments, the shoulder straps 36 can optionally be opened, for example with a quick release buckle or a three-bar buckle for length adjustment, to facilitate repair and storage or to even form a single long shoulder strap for shoulder carrying the bag in a messenger bag style. In other embodiments, the shoulder carrying device also comprises a hip belt.

In the second embodiment, the hidden pocket 38 has been omitted. All compartments are thus accessible with the panel 12 mounted to the main body 10. Further, instead of the bumper 46, the bike attachment device now comprises a second bike attachment element 54. The second bike attachment element 54 is attached to the second side 42 of the panel 12 at the second end 28. The second bike attachment element 54 according to the second embodiment comprises a bar and a lever. The lever is moveable along the bar and allows to fix bag to the luggage rack 32 at the lower end of the bag. The bag is therefore prevented from swinging on the bike 34. The panel 12 may comprise additional padding and/or the bag may have a deeper recess at the second end 28 of the attachment side 14 of the main body 10 to prevent the user from feeling such a rigid second bike attachment element 54 on his back when using the bag as a backpack.

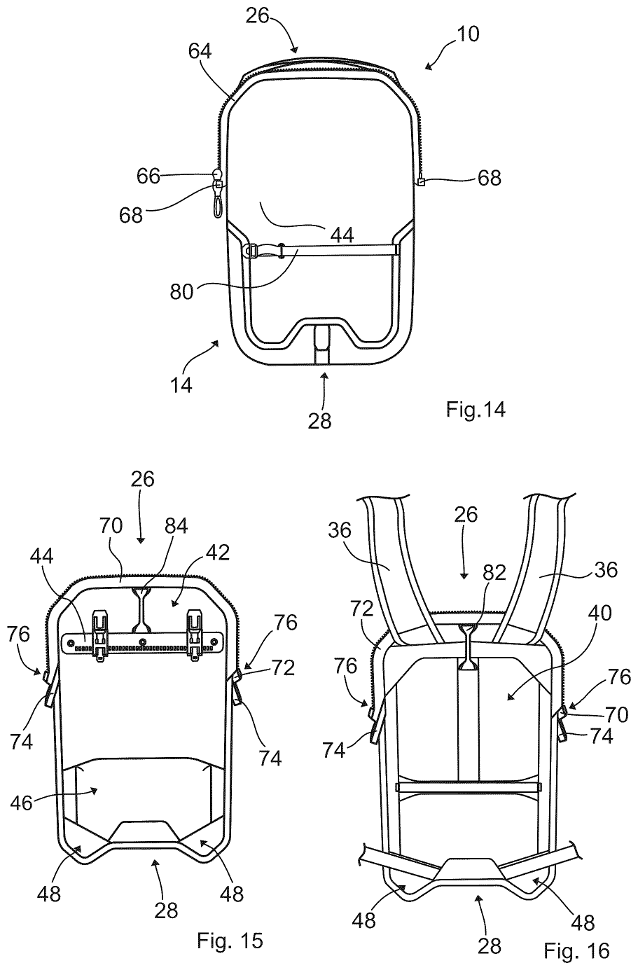

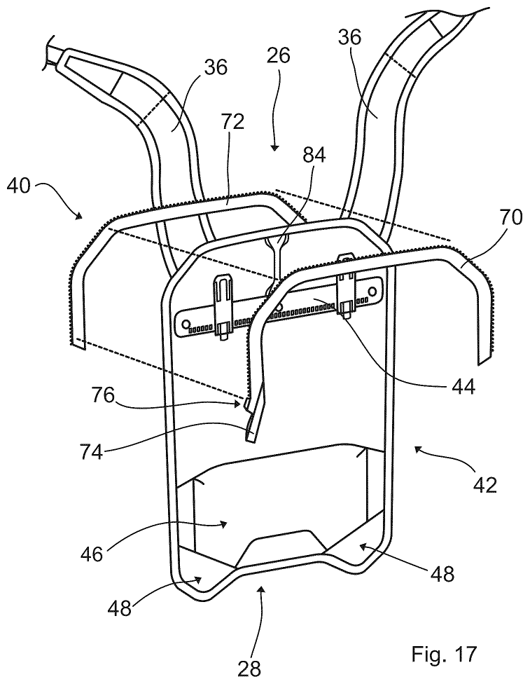

FIGS. 14 to 17 illustrate a third embodiment of the bag. In the third embodiment, the panel attachment device is configured differently. The panel attachment device does not comprise the Velcro fixation. Further, the panel 12 only has a bottom left and right corner 48 that are configured for insertion into a corresponding corner pocket of the main body 10. At the upper first end 26, the panel attachment device comprises a first panel attachment element 60 and a second panel attachment element 62 that are configured to provide a continuous attachment along a section of an upper edge of the panel 12. Said part of the panel attachment device is formed by a zipper. The zipper comprises a single zipper side piece 64 attached to the attachment side 14 of the main body 10. The single zipper side piece 64 of the main body 10 also has the slider 66 permanently attached thereto and a zipper end piece 68 at each of its ends. The zipper end pieces 68 allow alignment of a corresponding other side piece of the zipper when closing the zipper. The slider 66 may be configured as self-arresting in any position, for example depending on the position of a grasping element.

The panel attachment device according to the third embodiment comprises a first zipper side piece 70 attached to the top edge of the second side 42 of the panel 12. The zipper is configured so that the first zipper side piece 70 is zipped together with the single zipper side piece 64 of the main body 10 when the panel 12 is mounted to the main body 10 in the shoulder carrying configuration. The panel attachment device according to the third embodiment also comprises a second zipper side piece 72 attached to the upper edge of the first side 40 of the panel 12. The zipper is configured so that the second zipper side piece 72 is zipped together with the single zipper side piece 64 of the main body 10 when the panel 12 is mounted to the main body 10 in the pannier configuration.

As can be seen, the attachment device comprises a grasping element 74 in the form of a webbing loop fixed to a zipper alignment end 76 of each of the first and second zipper side piece 70, 72 and thus also fixed to the panel 12. That grasping element 74 allows simple guiding of the zipper alignment end 76 of the corresponding first or second zipper side piece 70, 72 when the user wishes to mount the panel 12 to the main body 10 in either the pannier configuration or backpack configuration. As can be seen, the zipper alignment ends 76 are spaced away from a rigid part of the panel 12 and are only attached thereto by a textile part of the corresponding zipper side piece 70, 72. Hence, grasping the grasping clement 74 allows the user to tension the corresponding zipper side piece 70, 72, thus facilitating the connection with the single zipper side piece 64 of the main body 10 and thus also closure of the zipper. The two zipper side pieces 70, 72 on the panel 12 allow easy closure of the zipper even with a very full bag. The user will have to slide the slider 66 from the same end and in the same direction regardless of the orientation in which the panel 12 is mounted and therefore which configuration is desired. The zipper may hold the panel 12 safely attached to the main body 10 even with high loads.

The bag according to the third embodiment comprises an additional strap 80 connected to the attachment side 14 of the main bag. The strap 80 is arranged at middle section of the attachment side 14 of the main body 10 between the first end 26 and the second end 28. The strap 80 is optionally length adjustable and may serve as a compression strap for the bag. Further, the strap 80 may tighten the pockets around the corners 48 of the panel 12 to further enhance attachment of the panel 12 to the main body 10. Further, the panel 12 may be slid underneath the strap 80 during mounting to the main body 10, in particular when the bottom corners 48 are inserted into the pockets of the main body 10. The strap 80 may thus hold the panel 12 upright parallel and close to the attachment side 14 of the main body 10, thus facilitating subsequent closure of the zipper at the top edge. The strap 80 may thus be arranged on top of the panel 12 attached to the main body 10. As such and depending on position and whether the strap 80 can be opened, the strap 80 can act as a hip belt. The strap 80 can thus form part of the shoulder carrying device that is attached to the main body 10. Further, the strap may also be used to attach the middle section or even the lower second end 28 of the bag to the luggage rack 32 of the bike 34. The strap 80 may thus form a second bike attachment element of the bike attachment device that is attached to the main body 10. Depending on the embodiment, the strap 80 may be configured for just one, some or all of the above-mentioned functions.

Additionally, the bag according to the third embodiment comprises a first carrying handle 82 attached to the first side 40 of the panel 12 and a second carrying handle 84 attached to the second side 42 of the panel 12. Each carrying handle 82, 84 is formed from a webbing loop with a smaller rounded middle section. The carrying handles 82, 84 allow easy hand carrying of the bag in either configuration and easy handling of the panel 12. The main body 10 may comprise a similar carrying handle at its top side and/or at the attachment side 14.

What is claimed is:

1. A bag for transportation of personal items, the bag comprising:
a main body with an attachment side and a panel with a first side and a second side opposite to the first side,
wherein the bag is adjustable between a shoulder carrying configuration and a pannier configuration,
wherein the bag comprises a panel attachment device that is configured to provide reversible mounting of the panel to the attachment side of the main body,
wherein the bag is adjusted into the shoulder carrying configuration when the panel is mounted to the attachment side of the main body with its first side facing away from the main body, and
wherein the bag is adjusted into the pannier configuration when the panel is mounted to the attachment side of the main body with its second side facing away from the main body.

2. The bag according to claim 1, wherein the panel comprises a shoulder carrying device arranged on the first side, wherein the shoulder carrying device comprises at least one shoulder strap attached with both ends to the first side of the panel.

3. The bag according to claim 2, wherein the shoulder carrying device comprises a hip belt arranged on the first side of the panel, and wherein the hip belt is attached with both ends to the first side of the panel.

4. The bag according to claim 2, wherein the bag is configured to form a first compartment between the panel and the main body in the pannier configuration to receive the at least one shoulder strap.

5. The bag according to claim 1, wherein the bag comprises a bike attachment device configured to attach the bag to a luggage rack of a bike.

6. The bag according to claim 5, wherein the bike attachment device comprises a first bike attachment element arranged on the second side of the panel, or
wherein the first bike attachment element is arranged at a first end of the second side of the panel.

7. The bag according to claim 5, wherein the bike attachment device comprises a second bike attachment element, wherein the second bike attachment element is attached to the attachment side of the main body or attached to the second side of the panel, or
wherein the second bike attachment element is arranged at a second end of the second side of the panel, or
wherein the second bike attachment element is arranged at a middle section of the second side of the panel.

8. The bag according to claim 5, wherein the bike attachment device comprises a bumper arranged at a second end of the second side of the panel.

9. The bag according to claim 5, wherein the bag is configured to form a second compartment between the panel and the main body in the shoulder carrying configuration to receive the bike attachment device.

10. The bag according to claim 1, wherein the panel is configured as a rigid element.

11. The bag according to claim 1, wherein the panel attachment device comprises a first panel attachment element fixed to the main body and a corresponding second panel attachment element fixed to the panel,
wherein the first panel attachment element is fixed to the attachment side of the main body, or
wherein the first panel attachment element and the second panel attachment element are configured to provide a continuous attachment along a section of an edge of the panel, or
wherein the panel attachment device comprises a plurality of first panel attachment elements and a plurality of second panel attachment elements,
wherein the second panel attachment elements are arranged along an edge of the panel or wherein at least a pair of second panel attachment elements are arranged on opposite edge sections of the panel.

12. The bag according to claim 1, wherein the panel attachment device comprises a pocket formed by the main body at the attachment side, wherein the pocket is configured to receive an end section of the panel.

13. The bag according to claim 1, wherein the panel attachment device comprises a zipper.

14. The bag according to claim 13, wherein the zipper comprises:
a single zipper side piece attached to the attachment side of the main body,
a first zipper side piece attached to the second side of the panel, wherein the zipper is configured to have the first zipper side piece zipped together with the single zipper side piece of the main body when the panel is mounted to the main body in the shoulder carrying configuration, and
a second zipper side piece attached to the first side of the panel, wherein the zipper is configured to have the second zipper side piece zipped together with the single zipper side piece of the main body when the panel is mounted to the main body in the pannier configuration.

15. The bag according to claim 13, wherein the panel attachment device comprises a grasping element formed as a webbing loop, fixed to a zipper alignment end of the panel.

16. The bag according to claim 1, wherein the panel comprises a first carrying handle on the first side of the panel, the panel comprises a second carrying handle on the second side of the panel, or both.
